(19) United States
(12) Patent Application Publication
(10) Pub. No.: US 2013/0007128 A1
(43) Pub. Date: Jan. 3, 2013

(54) APPARATUS AND METHOD FOR PROVIDING REALISTIC REMOTE EXPLORATION SERVICE BASED ON OPEN SOCIAL NETWORK SERVICE

(75) Inventors: Kwi Hoon KIM, Daejeon (KR); Chung Hyun AHN, Daejeon (KR); O Hyung KOWN, Daejeon (KR)

(73) Assignee: ELECTRONICS AND TELECOMMUNICATIONS RESEARCH INSTITUTE, Daejeon (KR)

(21) Appl. No.: 13/536,273

(22) Filed: Jun. 28, 2012

(30) Foreign Application Priority Data
Jun. 28, 2011 (KR) 10-2011-0063109
Apr. 5, 2012 (KR) 10-2012-0035472

(51) Int. Cl. G06F 15/16

(52) U.S. Cl. 709/204

(57) ABSTRACT

Discloses is an apparatus and method for providing a remote exploration service based on an open social network service (SNS). The apparatus for providing a remote exploration service may recommend an explorer terminal to a user terminal based on recommendation information of the user terminal, and transmit direction of movement data to the explorer terminal so that a remote exploration may be conducted along an exploration route designated by the user terminal.

### CROSS-REFERENCE TO RELATED APPLICATIONS

This application claims the benefit of Korean Patent Application No. 10-2011-0063109, filed on Jun. 28, 2011, in the Korean Intellectual Property Office, and No. 10-2012-0035472, filed on Apr. 5, 2012, in the Korean Intellectual Property Office, the disclosures of which are incorporated herein by reference.

### BACKGROUND

1. Field of the Invention

The present invention relates to a method of performing remote exploration through a remote explorer terminal based on a user terminal or a screen connected to the Internet, and more particularly, to an apparatus and method for recommending a remote explorer terminal to a user terminal, and an apparatus for providing a user with an image taken by the remote explorer terminal.

2. Description of the Related Art

With regard to a conventional method of providing a remote image to a user terminal, Korean Patent Laid-Open Publication No. 2009-0037741 uses a network camera to provide a remote image. A system disclosed in Korean Patent Laid-Open Publication No. 2009-0037741 includes a network camera for transmitting an image, and a main management apparatus for receiving an image and adjusting a network camera. The main management apparatus may communicate with a plurality of network cameras via a network. The network camera may transmit an image photographed by the network camera to the main management apparatus via the network. The main management apparatus may manage a start and an end of an image transmission from each network camera, and receive an image transmitted from the plurality of network cameras during the image transmission, thereby enabling the user terminal to verify the image.

However, according to the conventional method of providing a remote image to a user terminal, only an image at a fixed location may be viewed. Further, a remote user terminal may view an image displayed on a screen and thus, may fail to accurately and closely control an object to be photographed. In a conventional remote image service system, a remote user terminal may control an operation of a camera device. However, the remote user terminal may use an input device to control the operation and thus, may not control the camera device in a convenient and direct scheme.

### SUMMARY

An aspect of the present invention provides an apparatus for providing a remote exploration service that may provide a user terminal with exploration image data of domestic and foreign remote locations using explorer terminals linked to a social network service (SNS).

Another aspect of the present invention provides an apparatus for providing a remote exploration service that may recommend, to a user terminal, an explorer terminal to explorer an exploration area based on recommendation information transmitted by the user terminal.

Still another aspect of the present invention provides an apparatus for providing a remote exploration service that may provide direction of movement data to an explorer terminal so that the explorer terminal may conduct an exploration along an exploration route designated by a user terminal.

Yet another aspect of the present invention provides a user terminal that may output image data of an exploration area through being linked to a web map service.

Further another aspect of the present invention provides a user terminal that may output exploration image data transmitted by an explorer terminal along with additional image data or information, or transmit, to a simulator device, sensor data received from the explorer terminal.

According to an aspect of the present invention, there is provided an apparatus for providing a remote exploration service, the apparatus including an explorer terminal management unit to manage a plurality of explorer terminals linked to an SNS, an explorer terminal recommendation unit to recommend, to a user terminal, at least one explorer terminal for filming an exploration area among the plurality of explorer terminals based on recommendation information received from the user terminal, and a remote exploration service controller to control a connection of the recommended explorer terminal and the user terminal.

The apparatus may further include a direction of movement data provider to provide direction of movement data to the at least one explorer terminal by comparing exploration route data transmitted by the user terminal to location sensor data transmitted by the at least one explorer terminal.

According to another aspect of the present invention, there is provided a user terminal including a connection controller to control a connection to an explorer terminal or an apparatus for providing a remote exploration service, a data transmitter to transmit recommendation information or exploration route data to the apparatus for providing a remote exploration service connected through the connection controller, a data receiver to receive information of recommended explorer terminals from the apparatus for providing a remote exploration service connected through the connection controller, or receive sensor data of the explorer terminal or exploration image data from the explorer terminal, and a data output unit to output the exploration image data on a screen through a link to a web map service.

According to still another aspect of the present invention, there is provided a method of providing a remote exploration service performed by an apparatus for providing a remote exploration service, the method including managing a plurality of explorer terminals linked to an SNS, recommending, to a user terminal, at least one explorer terminal for filming an exploration area among the plurality of explorer terminals based on recommendation information received from the user terminal, and controlling a connection of the recommended explorer terminal and the user terminal.

The method may further include providing direction of movement data to the at least one explorer terminal by comparing exploration route data transmitted by the user terminal to location sensor data transmitted by the at least one explorer terminal when the user terminal designates an exploration route.

According to embodiments of the present invention, it is possible to receive a provision of exploration image data of an area desired by a user terminal using explorer terminals linked to an SNS.

According to embodiments of the present invention, it is possible to receive a recommendation of an explorer terminal through an area selected by a user terminal, an exploration route, a category, exploration history data, and the like.

According to embodiments of the present invention, it is possible to receive a provision of exploration image data along an exploration route designated by a user terminal using a mobile explorer terminal including a sensor.

According to embodiments of the present invention, it is possible to output, on a screen of a user terminal, exploration image data transmitted by an explorer terminal based on a web map service.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example in which an apparatus for providing a remote exploration service provides a user terminal with exploration image data of an explorer terminal according to embodiments of the present invention;

FIG. 2 is a diagram illustrating an operation of an apparatus for providing a remote exploration service recommending explorer terminals to a user terminal according to embodiments of the present invention;

FIG. 3 is a diagram illustrating an example in which an apparatus for providing a remote exploration service recommends explorer terminals to a user terminal according to embodiments of the present invention;

FIG. 4 is a diagram illustrating an example in which an apparatus for providing a remote exploration service recommends explorer terminals along with evaluation information to a user terminal according to embodiments of the present invention;

FIG. 5 is a diagram illustrating an example in which an apparatus for providing a remote exploration service receives a provision of recommendation information from a user terminal according to embodiments of the present invention;

FIG. 6 is a diagram illustrating an operation of an apparatus for providing a remote exploration service providing direction of movement data to an explorer terminal according to embodiments of the present invention;

FIG. 7 is a diagram illustrating an example of a screen to be output to a user terminal when an apparatus for providing a remote exploration service provides a service based on an exploration route according to embodiments of the present invention;

FIG. 8 is a diagram illustrating an operation of a user terminal outputting exploration image data, or transmitting sensor data to a simulation device according to embodiments of the present invention;

FIG. 9 is a flowchart illustrating an operation of an apparatus for providing a remote exploration service recommending explorer terminals to a user terminal according to embodiments of the present invention; and

FIG. 10 is a flowchart illustrating an operation of an apparatus for providing a remote exploration service based on an exploration route according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

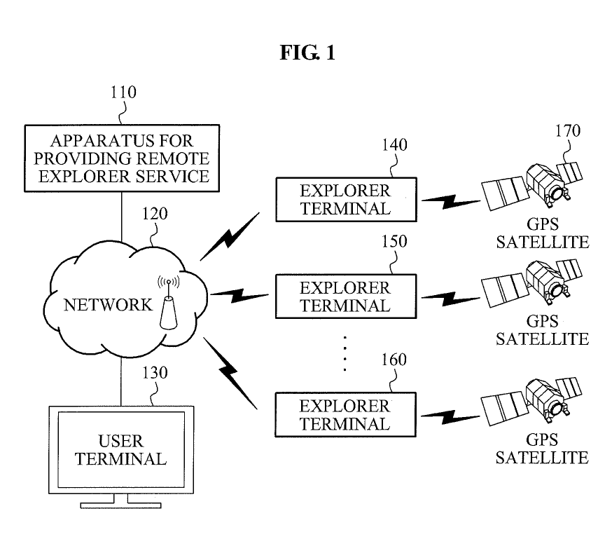

FIG. 1 is a diagram illustrating an example in which an apparatus for providing a remote exploration service provides a user terminal with exploration image data of an explorer terminal according to embodiments of the present invention.

An explorer may refer to a person exploring an exploration area in response to a remote exploration request, and store, in a profile, an area in which the explorer is located or an area of which the explorer is familiar and has specialized knowledge of. The explorer may access a remote exploration service of the apparatus for providing a remote exploration service when the explorer is ready for remote exploration. An explorer terminal may refer to a terminal carried by the explorer. A single explorer and explorer terminal may be included, and at least two explorers and explorer terminals may be included.

A user may refer to a person that requests or is provided with a remote exploration service, and the user terminal may refer to a terminal providing the remote exploration service.

Referring to FIG. 1, a system among an apparatus for providing a remote exploration service 110, a user terminal 130, and explorer terminals 140, 150, and 160 may be constructed based on a social network service (SNS). The SNS may refer to an online platform generating and strengthening a social relationship by performing communication, sharing information, expanding personal connections, and the like between users.

The explorer terminals 140, 150, and 160 may be constructed so that the explorer may carry the explorer terminals 140, 150, and 160, and move in the exploration area. For example, the explorer terminals 140, 150, and 160 may be constructed in a form of a smart phone, a smart pad, a car black box, and the like.

The explorer terminals 140, 150, and 160 may incorporate or be equipped with a photographing device such as a camera. The photographing device may be disposed at a rear of the explorer terminals 140, 150, and 160, or may be disposed at both of a front and the rear of the explorer terminals 140, 150, and 160. When the photographing device is disposed at both of the front and the rear of the explorer terminals 140, 150, and 160, the photographing device at the front may take an image of the explorer, and the photographing device at the rear may take an image of the exploration area. Here, the front and the rear may not correspond to absolute locations, and be reversed.

The explorer terminals 140, 150, and 160 may incorporate or be equipped with sensors such as a motion detection sensor, a temperature detection sensor, a wind speed measurement sensor, and the like. The sensors described in the foregoing may be used to provide a realistic sense of the exploration area by transmitting sensor data to the user terminal 130. The explorer terminals 140, 150, and 160 may be linked to a global positioning system (GPS) satellite 170 through a GPS sensor, or extract location sensor data of the explorer terminals 140, 150, and 160 using information of a communication base station. The sensors described in the foregoing are provided as an example, and are not limited thereto. The explorer terminals 140, 150, and 160 according to embodiments of the present invention may be equipped with a sensor that may measure conditions of an external environment.

The apparatus for providing a remote exploration service 110, and the explorer terminals 140, 150, and 160 may communicate with each other via a network 120. In this instance, the network 120 may correspond to one of a wired network and a wireless network. Exploration image data photographed by the explorer terminals 140, 150, and 160 or sensor data measured by the explorer terminals 140, 150, and 160 may be transmitted to the apparatus for providing a remote exploration service 110 or the user terminal 130 via the network 120. The exploration image data or the sensor data described in the foregoing may be transmitted directly to the user tent Anal 130 in a form of a peer to peer network (P2P), or be transmitted to the user terminal 130 via the apparatus for providing a remote exploration service 110, depending on a communication state of the network 120.

The user may access the SNS, and then request a remote exploration service from the apparatus for providing a remote exploration service 110. The user terminal 130 may receive image data or sensor data of the exploration area from the explorer terminals 140, 150, and 160. The user terminal 130 may correspond to a display device capable of communicating with an external device, and may be provided in a form of a smart television (TV), an Internet TV, an Internet protocol TV (IPTV), a connected TV, a smart phone, a tablet personal computer (PC), and the like. When the user is in motion, the user may be provided with the remote exploration service in a form of the smart phone, the tablet PC, and the like.

When the user requests the remote exploration service from the apparatus for providing a remote exploration service 110, the apparatus for providing a remote exploration service 110 may recommend at least one explorer terminal to the user terminal 130. When the user terminal 130 selects at least one explorer terminal, the apparatus for providing a remote exploration service 110 may manage a connection between the user terminal 130 and the explorer terminals 140, 150, and 160. In this instance, the apparatus for providing a remote exploration service 110 may determine whether to connect the user terminal 130 and the explorer terminals 140, 150, and 160 through the P2P, or via the apparatus for providing a remote exploration service 110 based on the communication state of the network 120.

In response to the user terminal 130 designating an exploration route, the apparatus for providing a remote exploration service 110 may provide direction of movement data to the explorer terminals 140, 150, and 160 by comparing exploration route data to the location sensor data transmitted by the explorer terminals 140, 150, and 160.

While the explorer performs an exploration, the explorer terminals 140, 150, and 160 and the user terminal 130 may exchange voice data. Thus, the user may deliver requirements about the remote exploration to the explorer. The requirements may include information about an area to explore, an analysis of a current exploration area, information about an exploration scheme.

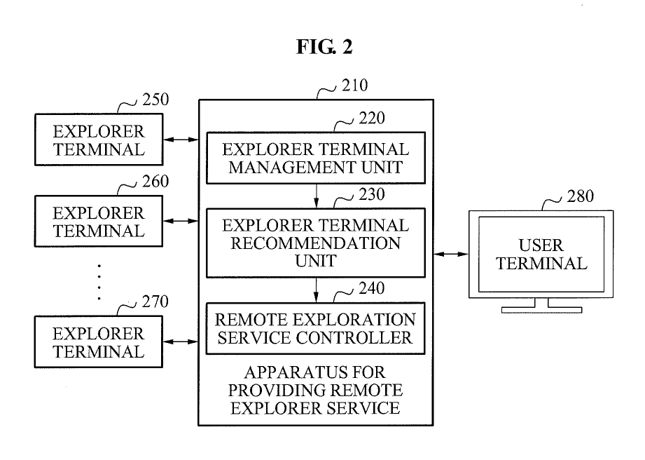

FIG. 2 is a diagram illustrating an operation of an apparatus for providing a remote exploration service recommending explorer terminals to a user terminal according to embodiments of the present invention.

Referring to FIG. 2, an operation of an apparatus for providing a remote exploration service 210 may include an explorer terminal management unit 220, an explorer terminal recommendation unit 230, and a remote exploration service controller 240.

The explorer terminal management unit 220 may manage data of explorer terminals 250, 260, and 270, and the data of the explorer terminals 250, 260, and 270 may be stored in the explorer terminal management unit 220 or an external memory. The data of the explorer terminals 250, 260, and 270 may include data about an area in which an explorer is located or an area of which the explorer is familiar and has specialized knowledge of, and data about exploration experiences of the explorer or whether the explorer accesses an SNS.

When a user requests a remote exploration service from the apparatus for providing a remote exploration service 210, the explorer terminal recommendation unit 230 may recommend the explorer terminals 250, 260, and 270 to a user terminal 280 based on data of the explorer terminals 250, 260, and 270. Here, the data of the explorer terminals 250, 260, and 270 may include data about an area in which an explorer is located or an area of which the explorer is familiar and has specialized knowledge of, data about evaluation information of the explorer or whether the explorer accesses an SNS, and the like. In this instance, at least one explorer terminal may be recommended, and the data of the explorer terminals 250, 260, and 270 described in the foregoing may be provided to the user terminal 280.

A scheme of recommending an explorer terminal by the explorer terminal recommendation unit 230 may be based on an exploration area and an exploration route selected by the user terminal 280, or exploration history data or a profile of the explorer. The scheme may also include recommending an explorer terminal in a form of a predetermined category such as an area of interest of the user, a news scene, a sports scene, and the like.

The explorer terminal recommendation unit 230 may display, through a link to a web map service, the explorer terminals 250, 260, and 270 to be recommended on a web map of an area the user desires to explore. The explorer terminal recommendation unit 230 may display, on the web map, an area in which the explorer terminals 250, 260, and 270 to be recommended are located.

The user terminal 280 may transmit recommendation information to the apparatus for providing a remote exploration service 210 to receive a recommendation of an explorer terminal. Here, the recommendation information may refer to information the user terminal 280 transmits to the apparatus for providing a remote exploration service 210 to receive a recommendation of an explorer terminal. In particular, the recommendation information may include an exploration area or an exploration route designated by the user terminal 280, a profile, a history of using a remote exploration service, information about selecting a predetermined category of the user, and the like. The predetermined category may include a popular exploration area, an exploration area associated with breaking news, a sports scene, a global tourist attraction, a jungle, and the like.

In response to the user terminal 280 selecting at least one explorer terminal among the recommended explorer terminals 250, 260, and 270, the remote exploration service controller 240 control an initial connection between a selected explorer terminal and the user terminal 280.

Here, when the selected explorer terminal is disconnected from the SNS, the remote exploration service controller 240 may transmit a message requesting a connection to the explorer terminals 250, 260, and 270, thereby providing a connection to the user terminal 280.

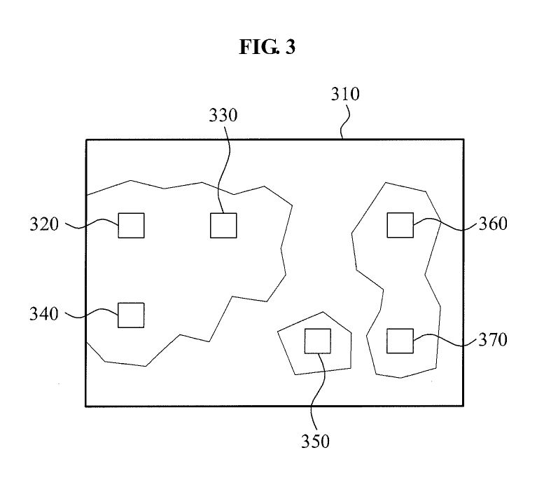

FIG. 3 is a diagram illustrating an example in which an apparatus for providing a remote exploration service recommends explorer terminals to a user terminal according to embodiments of the present invention.

In response to a user terminal selecting an exploration area or a predetermined category, an apparatus for providing a remote exploration service may recommend an explorer terminal associated with the exploration area or the predetermined category to the user terminal.

As an example, the apparatus for providing a remote exploration service may be linked with a web map service to recommend an explorer terminal. In this instance, a web map 310 of an area selected by a user may be displayed on a screen of the user terminal, and an area in which the explorer terminal is located or data of the explorer terminal may be displayed on the web map 310 in a form of icons or images 320, 330, 340, 350, 360, and 370. Here, the data of the explorer terminal may include an image of an exploration area assumed by an explorer, and image of cultural properties in the exploration area, data about whether the explorer accesses an SNS, or content about a profile of the explorer.

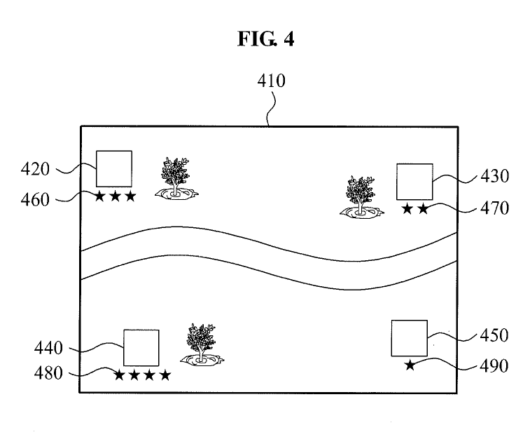

FIG. 4 is a diagram illustrating an example in which an apparatus for providing a remote exploration service recommends explorer terminals, along with evaluation information, to a user terminal according to embodiments of the present invention.

A scheme of recommending an explorer terminal by an apparatus for providing a remote exploration service may include displaying a web map 410 of an associated area on a screen of a user terminal through being linked to a web map service, and displaying evaluation information 460, 470, 480, and 490 about the explorer terminal on the web map 410 along with data of the explorer terminal in forms of icons or images 420, 430, 440, and 450. In this instance, the data of the explorer terminal may be the same as the explorer terminal described with reference to FIG. 3 and thus, a repeated description will be omitted for conciseness.

The evaluation information 460, 470, 480, and 490 about the explorer terminal may correspond to a sum of evaluations provided by another user. The evaluation information 460, 470, 480, and 490 may be expressed by a list of figures having a predetermined shape, a graph, a number, and the like.

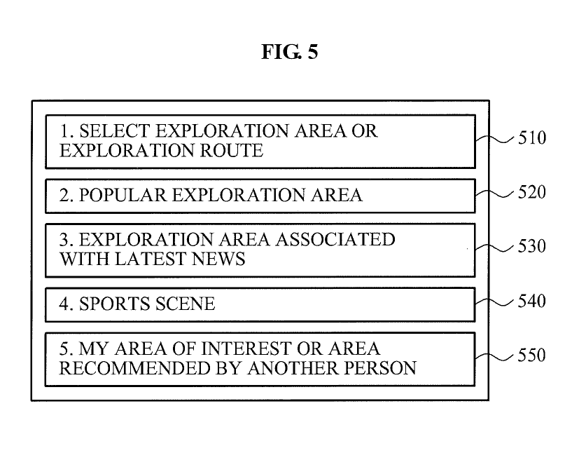

FIG. 5 is a diagram illustrating an example in which an apparatus for providing a remote exploration service receives a provision of recommendation information from a user terminal according to embodiments of the present invention.

An apparatus for providing a remote exploration service may receive recommendation information from a user terminal, and select an explorer terminal to be recommended to the user terminal. FIG. 5 illustrates recommendation information to be output on a screen of the user terminal. Here, the recommendation information may refer to the recommendation information of FIG. 2.

Referring to a display area 510 of FIG. 5, the user terminal may display an exploration area or an exploration route as recommendation information for recommending an explorer terminal.

Referring to display areas 520, 530, 540, and 550 of FIG. 5, the user terminal may display a predetermined category as recommendation information for recommending an explorer terminal. That is, the apparatus for providing a remote exploration service may recommend an explorer terminal to the user terminal by classifying explorer terminals into predetermined categories. Here, the category may be determined based on a profile or an exploration history of a user. In particular, the profile of the user may include a current location, an area of interest, a field of interest, a search history, a product purchase history, and the like of the user.

For example, when the area of interest of the profile of the user terminal corresponds to a predetermined nation, the apparatus for providing a remote exploration service may recommend, to the user terminal, explorer terminals associated with exploring the predetermined nation. When an interest in the profile of the user terminal corresponds to watching a soccer game, the apparatus for providing a remote exploration service may recommend, to the user terminal, explorer terminals associated with an area in which a soccer game is being held.

The predetermined category may include an area associated with a predetermined subject such as a popular exploration area, an exploration area associated with breaking news, or a sports scene, and the like. The predetermined category may be automatically generated to customize the user terminal to correspond to the profile of the user terminal.

For example, when interest information in the profile of the user terminal corresponds to sports, a category configuration of a sports scene exploration may be automatically added. When the user selects a predetermined category, the apparatus for providing a remote exploration service may recommend explorer terminals in an area associated with the predetermined category to the user terminal.

The predetermined categories described in the foregoing are not limited to examples described in the foregoing, and may be changed or added to due to changes in the profile of the user terminal or a difference in a method of providing a remote exploration service.

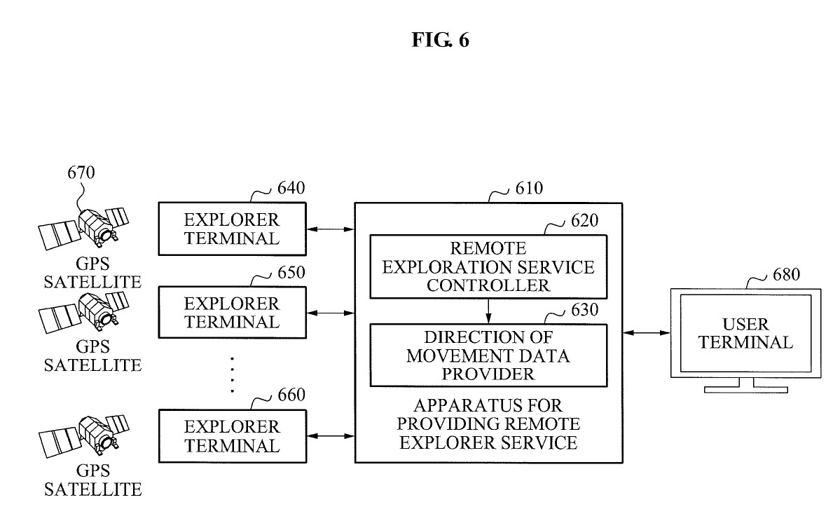

FIG. 6 is a diagram illustrating an operation of an apparatus for providing a remote exploration service providing direction of movement data to an explorer terminal according to embodiments of the present invention.

When a user selects an exploration along an exploration route, an apparatus for providing a remote exploration service 610 may receive exploration route data from a user terminal 680. The exploration route data may refer to data about a route along which an explorer conducts an exploration, and include data about a starting point, a destination, an intermediate route, a rest stop, and the like.

In this instance, exploration image data or sensor data of explorer terminals 640, 650, and 660 may be transmitted to the user terminal 680 via the apparatus for providing a remote exploration service 610.

A remote exploration service controller 620 may manage a connection between the user terminal 680 and the explorer terminals 640, 650, and 660. The remote exploration service controller 620 may receive exploration route data from the user terminal 680, receive location sensor data generated through being linked to a GPS satellite 670 from the explorer terminals 640, 650, and 660, and provide the received exploration route data and location sensor data to a direction of movement data provider 630.

The direction of movement data provider 630 may compare the exploration route data transmitted by the user terminal 680 to the location sensor data transmitted by the explorer terminals 640, 650, and 660. The direction of movement data provider 630 may provide direction of movement data to the explorer terminals 640, 650, and 660 so that the explorer may conduct an exploration along an exploration route designated by the user.

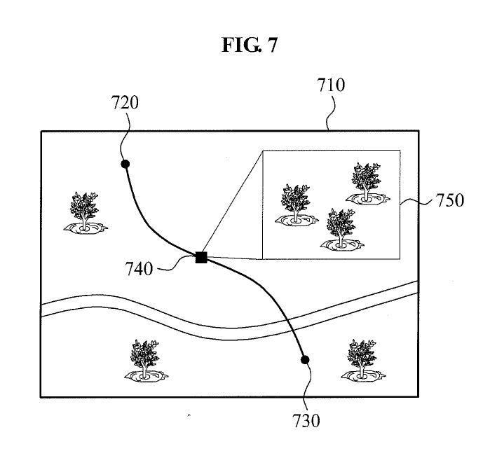

FIG. 7 is a diagram illustrating an example of a screen to be output to a user terminal when an apparatus for providing a remote exploration service provides a service based on an exploration route according to embodiments of the present invention.

A user terminal may display a web map 710 associated with an exploration area through being linked to a web map service. A starting point 720, a destination 730, a current location 740, or an entire exploration route may be displayed on the web map 710.

In this instance, exploration image data 750 being transmitted by an explorer terminal may be output on a portion of an area on a screen, and a plurality of pieces of exploration image data may be displayed on a single screen depending on a number of explorer terminals. The user terminal may output the exploration image data 750 of the user terminal on an entire screen, or output additional information about an exploration area, along with the exploration image data 750. Here, the additional information may include weather, a population, a history, associated news, and the like.

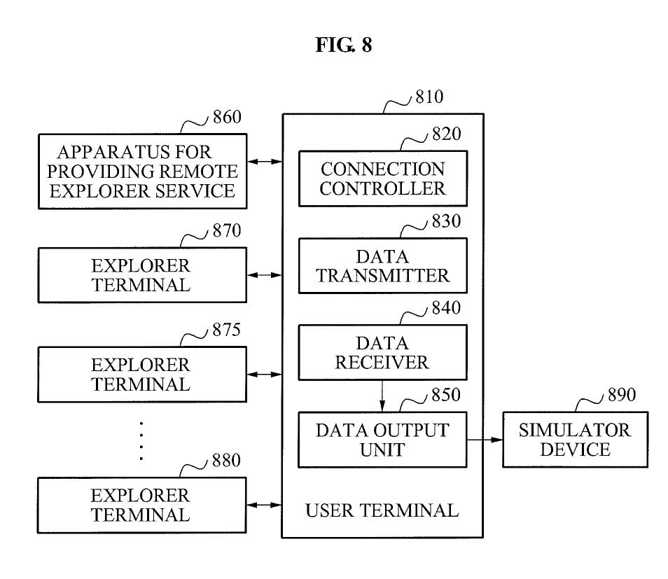

FIG. 8 is a diagram illustrating an operation of a user terminal outputting exploration image data, or transmitting sensor data to a simulation device according to embodiments of the present invention.

A user terminal 810 may include a connection controller 820, a data transmitter 830, a data receiver 840, and a data output unit 850.

The connection controller 820 may manage a connection to an apparatus for providing a remote explorer service 860 or explorer terminals 870, 875, and 880. In particular, when the connection controller 820 receives exploration image data or sensor data from the apparatus for providing a remote explorer service 860 or the explorer terminals 870, 875, and 880, the connection controller 820 may manage a start and an end of a data reception.

The data transmitter 830 may transmit recommendation information or exploration route data to the apparatus for providing a remote explorer service 860, or transmit voice data to the explorer terminals 870, 875, and 880.

The data receiver 840 may receive, via a network, exploration image data taken by the explorer terminals 870, 875, and 880, location sensor data of the explorer terminals 870, 875, and 880, sensor data measured by the explorer terminals 870, 875, and 880, or voice data transmitted by the explorer terminals 870, 875, and 880.

The data output unit 850 may output, to a screen of a display device, the exploration image data or the location sensor data received by the data receiver 840. In this instance, the exploration image data or the location sensor data may be output on a web map through being linked to a web map service.

The data output unit 850 may output additional information associated with the exploration image data received by the data receiver 840 along with the exploration image data. The additional information may include geographic information regarding an exploration area, news associated with the exploration area, and the like.

The data output unit 850 may transmit, to a simulator device 890 connected to the user terminal 810, the sensor data of the explorer terminals 870, 875, and 880 received by the data receiver 840. Here, the simulator device 890 may be incorporated in the user terminal 810, or may correspond to a separate device connected to the user terminal 810.

The simulator device 890 may receive and output sensor data transmitted by the user terminal 810. The sensor data may be used to increase a realistic sense of the exploration area. For example, the sensor data may include temperature of the exploration area, a degree of motion of the explorer terminals 870, 875, and 880, a measure of a wind speed in the exploration area, a degree of brightness, and the like.

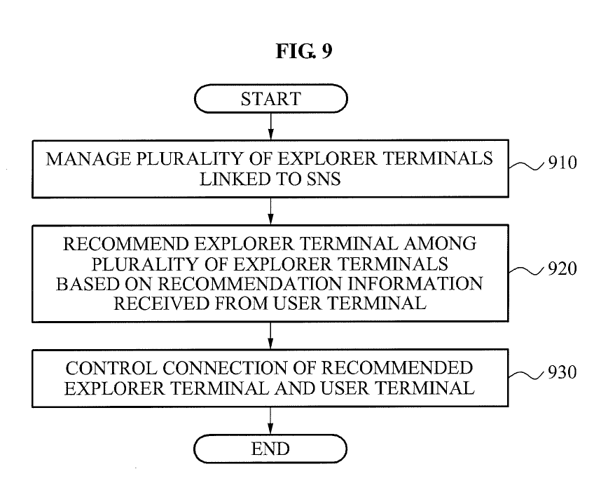

FIG. 9 is a flowchart illustrating an operation of an apparatus for providing a remote exploration service recommending explorer terminals to a user terminal according to embodiments of the present invention.

In operation 910, an operation of an apparatus for providing a remote exploration service may manage a plurality of explorer terminals linked to an SNS. The apparatus for providing a remote exploration service may manage data about an area in which an explorer is located or an area of which the explorer is familiar and has specialized knowledge of, and data about an exploration experience of the explorer or whether the explorer currently accesses an SNS.

In operation 920, the apparatus for providing a remote exploration service may recommend an explorer terminal among the plurality of explorer terminals to a user terminal based on recommendation information received from the user terminal.

A scheme of recommending an explorer terminal by the apparatus for providing a remote exploration service may be based on an exploration area and an exploration route selected by the user terminal, or exploration history data or a profile of the explorer, or may include a recommending scheme in a predetermined category form such as an area of interest of a user, a news scene, a sports scene, and the like. That is, the apparatus for providing a remote exploration service may recommend an explorer terminal to the user terminal by classifying explorer terminals into predetermined categories.

The apparatus for providing a remote exploration service may display, through a link to a web map service, the explorer terminal to be recommended on a web map of an area the user desires to explorer. The apparatus for providing a remote exploration service may display, on the web map, an area the explorer terminal to be recommended are located.

In operation 930, the apparatus for providing a remote exploration service may control a connection between the recommended explorer terminal and the user terminal. When the selected explorer terminal is disconnected from the SNS, the apparatus for providing a remote exploration service may transmit a message requesting a connection to the explorer terminal, thereby providing a connection to the user terminal.

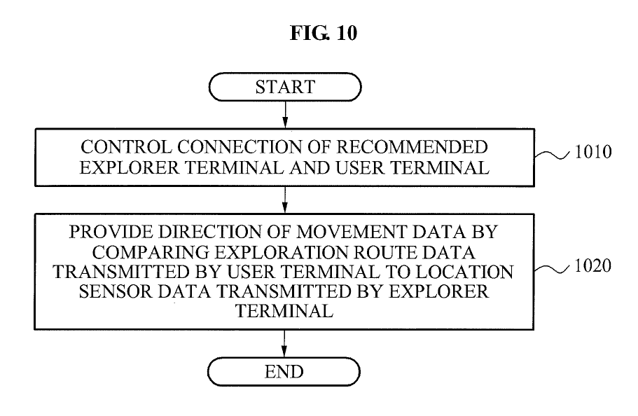

FIG. 10 is a flowchart illustrating an operation of an apparatus for providing a remote exploration service based on an exploration route according to embodiments of the present invention.

In operation 1010, an apparatus for providing a remote exploration service may control a connection between a recommended explorer terminal and a user terminal. The apparatus for providing a remote exploration service may receive exploration route data from the user terminal, and receive location sensor data from the explorer terminal.

In operation 1020, the apparatus for providing a remote exploration service may provide direction of movement data to the explorer terminal by comparing the exploration route data transmitted by the user terminal to the location sensor data transmitted by the explorer terminal. Thus, an explorer may conduct an exploration along an exploration route designated by a user.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for providing a remote exploration service, the apparatus comprising:
an explorer terminal management unit to manage a plurality of explorer terminals linked to a social network service (SNS);
an explorer terminal recommendation unit to recommend, to a user terminal, at least one explorer terminal for filming an exploration area among the plurality of explorer terminals based on recommendation information received from the user terminal; and
a remote exploration service controller to control a connection of the recommended explorer terminal and the user terminal.

2. The apparatus of claim 1, wherein the explorer terminal recommendation unit displays information of the plurality of explorer terminals on a web map through a link to a web map service.

3. The apparatus of claim 1, wherein the explorer terminal recommendation unit identifies the at least one explorer terminal to be recommended to the user terminal among the plurality of explorer terminals linked to the SNS based on an exploration route or an area selected by the user terminal.

4. The apparatus of claim 1, wherein the explorer terminal recommendation unit identifies the at least one explorer terminal to be recommended to the user terminal by classifying the plurality of explorer terminals into predetermined categories.

5. The apparatus of claim 1, wherein the explorer terminal recommendation unit recommends, to the user terminal, the at least one explorer terminal along with evaluation information of the at least one explorer terminal.

6. The apparatus of claim 1, wherein the explorer terminal recommendation unit recommends, to the user terminal, the at least one explorer terminal associated with an area of interest or a predetermined subject based on exploration history data or a profile of the user terminal.

7. The apparatus of claim 1, wherein, when the at least one explorer terminal is disconnected from the SNS, the remote exploration service controller transmits a connection request message to the at least one explorer terminal.

8. The apparatus of claim 1, further comprising:
a direction of movement data provider to provide direction of movement data to the at least one explorer terminal by comparing exploration route data transmitted by the user terminal to location sensor data transmitted by the at least one explorer terminal.

9. A user terminal, comprising:
a connection controller to control a connection to an explorer terminal or an apparatus for providing a remote exploration service;
a data transmitter to transmit recommendation information or exploration route data to the apparatus for providing a remote exploration service connected through the connection controller;
a data receiver to receive information of recommended explorer terminals from the apparatus for providing a remote exploration service connected through the connection controller, or receive sensor data of the explorer terminal or exploration image data from the explorer terminal; and
a data output unit to output the exploration image data on a screen through a link to a web map service.

10. The user terminal of claim 9, wherein the data output unit outputs the exploration image data received from the explorer terminal along with additional image data or information.

11. The user terminal of claim 9, wherein the data transmitter transmits the sensor data to a simulator device included in the user terminal or connected to the user terminal.

12. A method of providing a remote exploration service performed by an apparatus for providing a remote exploration service, the method comprising:
managing a plurality of explorer terminals linked to a social network service (SNS);
recommending, to a user terminal, at least one explorer terminal for filming an exploration area among the plurality of explorer terminals based on recommendation information received from the user terminal; and
controlling a connection of the recommended explorer terminal and the user terminal.

13. The method of claim 12, wherein the recommending comprises identifying the at least one explorer terminal to be recommended to the user terminal among the plurality of explorer terminals linked to the SNS based on an exploration route or an area selected by the user terminal.

14. The method of claim 12, wherein the recommending comprises identifying the at least one explorer terminal to be recommended to the user terminal by classifying the plurality of explorer terminals into predetermined categories.

15. The method of claim 12, wherein the recommending comprises recommending, to the user terminal, the at least one explorer terminal along with evaluation information of the at least one explorer terminal.

16. The method of claim 12, wherein the recommending comprises recommending, to the user terminal, the at least one explorer terminal associated with an area of interest or a predetermined subject based on an exploration history or a profile of the user terminal.

17. The method of claim 12, wherein, when the at least one explorer terminal is disconnected from the SNS, the controlling comprises transmitting a connection request message to the at least one explorer terminal.

18. The method of claim 12, further comprising:
providing direction of movement data to the at least one explorer terminal by comparing exploration route data transmitted by the user terminal to location sensor data transmitted by the at least one explorer terminal when the user terminal designates an exploration route.
